(19) United States
(12) Patent Application Publication
(10) Pub. No.: US 2005/0015217 A1
(43) Pub. Date: Jan. 20, 2005

(54) Analyzing events

(76) Inventors: Galia Weidl, Steinenbronn (DE); Gerhard Vollmar, Meckenheim (DE)

Correspondence Address: VENABLE, BAETJER, HOWARD AND CIVILETTI, LLP, P.O. BOX 34385, WASHINGTON, DC, 20043-9998, US

(21) Appl. No.: 10/845,616

(22) Filed: May 14, 2004

(30) Foreign Application Priority Data
Nov. 16, 2001 (GB) 0127551.0
Nov. 15, 2002 (WO) PCT/EP02/12823

(51) Int. Cl. G06F 11/30

(52) U.S. Cl. 702/185

(57) ABSTRACT

An analyzer arrangement for provision of information about a facility by means of root cause analysis. Storage assembly stores a data model that associates with the facility. The data model contains information about possible events, hypotheses for the root causes of the possible events and symptoms for the hypotheses. A processor provides root cause analysis based on the data model. An input inputs additional information for use in root cause analysis. An adaptor modifies the data model based on the additional information.

### FIELD OF THE INVENTION

The present invention relates to analysis of events, and in particular, to root cause analysis of events that have occurred or may occur in association with the subject of the analysis. The analysis can be provided by means of a computerised analyser.

### BACKGROUND OF THE INVENTION

The subject of the analysis may be any facility such as an industrial facility. A typical industrial facility employs various types of equipment and/or process stages for various purposes. An industrial facility may comprise, for example, a production facility such as a factory or a similar production unit. An industrial facility may also be for provision of different processes such as continuous, discrete, or batch like processes and so on. Examples of such industrial facilities include, without limiting to these, chemical plants, oil refineries, pharmaceutical or petro-chemical industries, food and beverage industries, pulp and paper mills, power plants, steel mills, metals and foundry plants, automated factories and so on. Examples of other facilities include arrangements such as automatic storage systems, automated goods and/or package handling systems, for example, freight handling systems such as airport baggage loading and transfer systems, communication systems, transport systems (e.g. railways), buildings and other constructions, and so on. The term facility shall also be understood to refer to any subsystem e.g. in an industrial plant. A subsystem may be e.g. a manufacturing cell, a machine, a component, a process stage and so on.

A facility and the operation of the facility or some components thereof may need to be analysed for various reasons. An operator of an equipment e.g. in a factory may wish to analyse what was the root cause of an event. The term ‘event’ shall be understood to refer to anything that may occur in the facility during the operation thereof. For example, the event may comprise an abnormality or failure/fault or any other deviation from normal operation conditions of the facility. The operator may also wish to be able predict what will happen if an action is taken. An operator may also wish to analyse in advance what might be the root cause of a deviation from optimal operating conditions of facility and to remove the source of the deviation before e.g. any actual failure occurs, the deviation being an indication of a failure built-up.

The results of the analysis could then be used e.g. as a support in the control of a process, for producing information that is needed later on e.g. when processing an end product of the process, for diagnostic of events such as a fault or other abnormality in a machine, for being able to avoid taking action that may be harmful or even dangerous, and so on. It is also possible to diagnose end products or their parts and/or optimise assets by means of analysis of the production process thereof.

Computerised analysers are known. The computerised analysers comprise hardware and software for processing data in accordance with a predefined set of analysing rules. Different information collecting and monitoring means (e.g. different sensors, meters and other observation means) may be provided for collection of the data for the analysis. The data may be collected and input into the system automatically, semi-automatically, or manually.

Information available for analysing deviations from normal operation conditions such as failures or other abnormalities or events may be incomplete. This may be especially the case in large and/or complex facilities comprising a substantially large number of different equipment. A facility may comprise equipment or process stages of which no beforehand determined or learned information is available. In addition, any modification in the facility and/or replacement components may change the data prepared for the analysis. For example, relative the weightings of the importance of components and/or symptoms caused by the components may change. The domain knowledge or data associated with a facility or some part of the facility to be analysed and/or the event domain may thus be incomplete and/or outdated. The domain knowledge or data associated with a facility to be analysed and/or the event domain may also include uncertainties. Therefore it may be difficult to identify causes of events in large and/or complex installations.

The inventors have found that there is a need for a solution that accelerates the analysis for finding the initial cause of an event such as the source of a problem or other abnormality. This is felt especially important in association with substantially large and/or complex facilities. An analyser should be able to handle a substantial diversity of factors in the context of dynamic and/or changing conditions, such as changing process. The analyser should possess the power of quick deduction under uncertain or incomplete data, as this might assist in provision of quick guidance for a failure analyst.

### SUMMARY OF THE INVENTION

Embodiments of the present invention aim to address one or several of the above problems.

According to one aspect of the present invention, there is provided a analyser arrangement for provision of information about a facility by means of root cause analysis, comprising:
storage means for storing a data model that associates with the facility, said data model containing information about possible events, hypotheses for the root causes of the possible events and symptoms for the hypotheses;
processor means for root cause analysis based on the data model;
input means for input of additional information for use in root cause analysis; and
adaptation means for modifying the data model based on the additional information.

In a more specific form the processor means is arranged to process a causally oriented data model. The causally oriented data model may comprise a plurality of objects and information associated with conditional probabilities between the objects, the adaptation means being arranged to modify said conditional probabilities. The conditional probabilities may be modified by modifying at least one conditional probability table of the causally oriented data model. The processor means may process simultaneously at least two root cause hypotheses. The causally oriented data model may be generated based on a structured data model by a translator engine. The adaptation means may modify the structured data model.

The adaptation means may be arranged to modify the structure of the data model.

The additional information may be used for adapting the data models in accordance with changes in the facility. The additional information may comprise information about events occurred in association with the facility, operator feedback, information about new symptoms, information about new root cause hypotheses, information from a system controlling the facility. The additional information may be provided based on quantitative data associated with failure frequencies and/or failure weightings of variables associated with the facility, expertise and/or experiences and/or historical data, statistical and/or physical and/or process and/or performance models of the facility.

The analyser arrangement may also comprise a classifier for substantially real-time classification of said additional information and symptoms before they are input as evidences into the root cause analysis.

The data model may be stored as an aspect of an object in a model describing a facility. The data model can be adapted to better correspond the facility by replacing the aspect containing the data model with an aspect containing an adapted data model.

The data model may be generated and stored in a central storage entity based on information from a plurality of individual sources.

The processor means may analyse the data model to simulate possible impacts of an intended action before any real action is performed.

According to another aspect of the present invention there is provided a method of analysing a facility by means of root cause analysis, comprising:
preparing and storing a data model that associates with the facility in storage means, said data model containing information about possible events, hypotheses for the root causes of the possible events and symptoms for the hypotheses;
input of additional information associated with the facility;
modifying the data model based on the additional information; and
analysing the facility based on the modified data model.

According to another aspect of the present invention there is provided a computer program product comprising program code means for performing the above steps when the program is run on a computer.

According to another aspect of the present invention there is provided a movable user device for use in conjunction with a root cause analyser for analysing a facility based on a data model that associates with the facility, said data model containing information about possible events, hypotheses for the root causes of the possible events and symptoms for the hypotheses, the movable user device comprising user interface means for input of additional information for modification of said data model.

The embodiments may assist in provision of a substantially fast and flexible guidance tool for operators. An operator may be provided with a tool for finding root causes for deviations and/or tendencies for deviations from normal operating conditions. A list of root causes may be ranked after probabilities. Some of the embodiments enable collection and utilisation of information about expertise and experience within a problem domain. When tuned by such information the root cause analysis may then reflect some new relations in the problem domain and become more objective. The analysis becomes also more up-to-date as the analysis may take operator feedback or any other substantially real-time information into account whereby a substantially real-time root cause analysis is provided. The proposed arrangement may generate updated data models for the real time root cause analysis. The analysis is not necessarily limited to only one possible root cause but several root causes may be analysed simultaneously. Some of the embodiments provide a tool for predictive diagnostic, especially in systems wherein real time root cause analysis based on up-to-date data is facilitated.

### BRIEF DESCRIPTION OF DRAWINGS

For better understanding of the present invention, reference will now be made by way of example to the accompanying drawings in which:

FIG. 1 is a schematic presentation showing a control system;

FIG. 2 is a block chart for an embodiment of the present invention;

FIG. 3 is a flowchart in accordance with an embodiment;

FIG. 4 is a block chart showing use of a Bayesian scheme for root cause analysis;

FIG. 5 shows a hierarchically structured data model;

FIGS. 6 and 7 show causally oriented data models generated in accordance with the principles of the present invention;

FIGS. 8 to 10 relate to graphical user interfaces that may be displayed for a user;

FIG. 11 shows a data structure describing the facility of FIG. 1;

FIGS. 12 and 13 show further embodiments; and

FIG. 14 shows a portable device for use in accordance with the present invention.

### DESCRIPTION OF PREFERRED EMBODIMENTS OF THE INVENTION

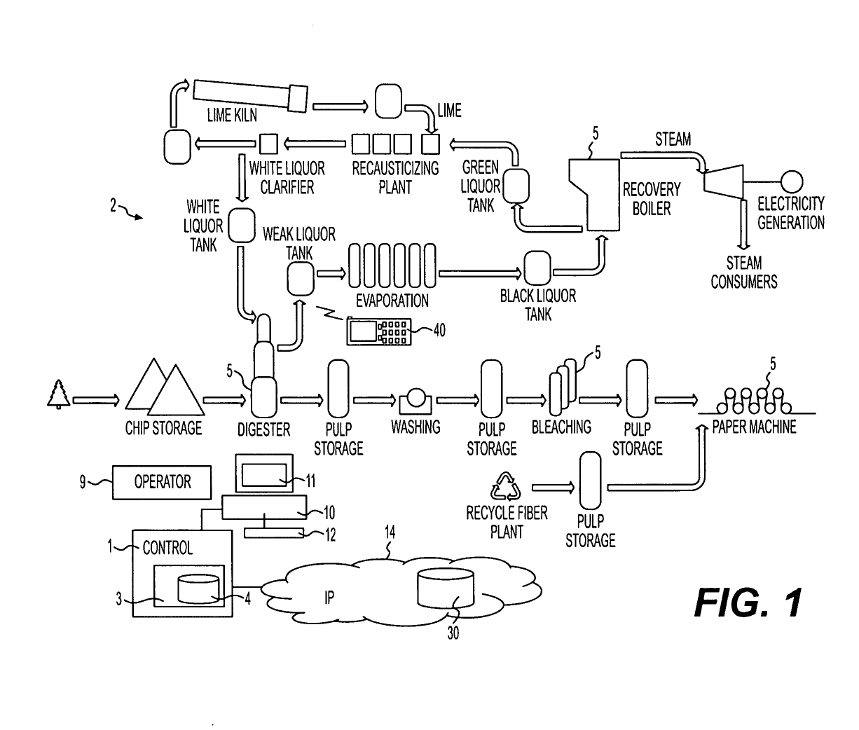

Reference is first made to FIG. 1 which shows a schematic view of a control system 1 adapted to monitor and control operation of a facility 2. The skilled person is familiar with the various functions of a control system, and these are therefore not described herein in any greater detail. It is sufficient to note that the control system 1 may be used for obtaining efficient and safe operation of a facility and/or for provision of information regarding the facility and/or equipment of the facility. To provide these objectives a control system may be adapted to monitor, analyse and manipulate the facility.

In FIG. 1 the facility to be controlled by the control system 1 comprises a pulp and paper mill 2. Since the facility as such does not form an essential element of the invention, it shall not be described in any greater detail. It is sufficient to note that a facility may comprise a plurality of various components and/or stages 5. For example, the pulp and paper mill 2 may comprise a plurality of sub-process stages such as digesting, washing, bleaching, recycling, paper formation, evaporation, recovery, and so on, each of these including a substantial number of various different components. It shall be appreciated that the facility to be analysed may comprise any facility such as any industrial facility, a municipal facility, an office, a building or other construction, and so on.

As explained above, a complex process may include a substantial number of variables. The domain knowledge or data associated with the facility or some part of the facility and/or the event domain may not be complete. The data may also become easily outdated as the conditions change. The domain knowledge or data associated with the complex facility and/or the event domain may also include uncertainties.

The computerised control system 1 includes an analyser entity 3. The analyser 3 may comprise appropriate data processor means adapted for processing data based on object oriented data processing techniques. Well known examples of object oriented technologies, without being limited to these, include known programming languages such as C++ or Java.

The analyser function 3 of the control system 1 may analyse the facility 2 based on data stored in a data storage means. At least a part of the data for the analysis may be fetched via a data communication network such as the IP (the Internet Protocol) based Internet 14 or an intranet or a local area network (LAN) from a remote database 30. The data communication network may provide packet switched data communication.

A local database 4 can also be provided, either in addition to the remote database or as a sole database for the analysis. The local database 4 may be provided in connection with the other data storage functions of the control system 1.

The skilled person is familiar with various possibilities for the provision of the data storage means (local and remote) and therefore these will not be described in any great detail.

Generation and use of the data stored in the data storage means 4, 30 will be described in more detail later. At this stage it is sufficient to note that at least a part of the data for the analysis may have been generated beforehand based on information that has been gathered from various sources. At least a part of the data may have been gathered and/or updated after installation of initial data in the data storage means. Examples of the possibilities for the adaptive addition and update of data will also be described in more detail later.

A user terminal 10 is for provision of e.g. an operator 9 with a user interface. The user terminal 10 is connected to the control system 1 by means of an appropriate communication link. The user terminal 10 is provided with display means 11 adapted for providing the user with a graphical user interface (GUI). The user terminal 10 may also be provided with input interface means such as a keyboard 12, a touch screen, a mouse (not shown) and other auxiliary devices.

The analyser entity 3 is preferably adapted to provide a root cause analysis by means of an automated simultaneous verification of several root cause hypotheses based on the data stored in the data storage means and additional information input e.g. by the operator 9. Simultaneous processing may be especially advantageous if the root cause hypotheses share common symptoms. In addition of predefined information the system may also employ learning that is based on event information.

The skilled person is familiar with the basic principles of the root cause analysis. As proposed by its name the root cause analysis can be used for determining root causes of problems. Removal of a determined root cause should also remove the origin of the problem behind an observed effect or failure. The root cause analysis may be used e.g. in a maintenance troubleshooting for anticipation and regulation of systemic causes of maintenance and/or process control problems, in finding the optimal sequence of maintenance and/or control actions, and for asset and/or process optimisation.

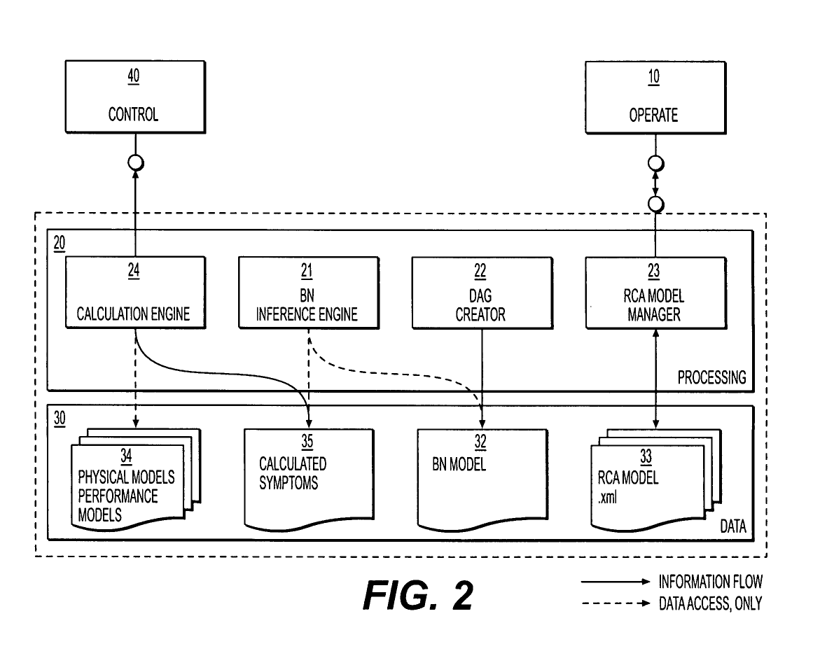

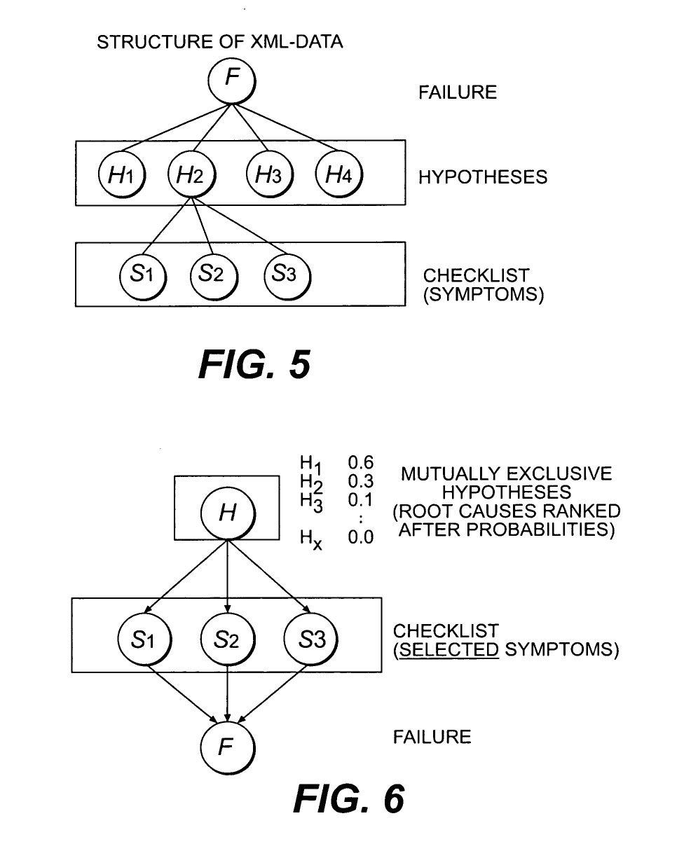

In a preferred embodiment the data to be analysed is organised in causally oriented data models. An analyser wherein the analysis may be processed based on the causally oriented data models will now be described with reference to FIG. 2. A possible procedure for the generation of causally oriented data models based on hierarchically structured data models will be described in more detail with reference to FIGS. 5 to 7.

FIG. 2 is a schematic block diagram showing functional entities of a possible analyser arrangement. The analysis can be seen as being divided between different hierarchical layers. Various possible processing functions are shown in a processing layer 20, the processing layer 20 comprising functional entities such as a Bayesian network (BN) inference engine 21, a directed acyclic graph (DAG) creator 22, a root cause analysis (RCA) model manager 23, and a calculation engine 24.

The BN inference engine 21 is adapted to produce reasoning under uncertain and/or incomplete data on possible root causes of a failure or other abnormality based on evidences entered as symptoms in the root cause analysis (RCA) model manager 23. At least a part of the symptoms can be gathered as real-time evidences in order to provide a substantially real-time root cause analysis. The real-time gathering of the symptom information may occur on-line.

The inference engine 21 may access evidences automatically from a control system such as a distributed control system (DCS). The evidences may be input by the operator. The evidences may be provided as a combination of operator checked symptoms, new experiences the operator has within the problem domain, measurement results (e.g. performance metrics, temperature, quality metrics and so on), alarms, computed physical variables indicating a deviation (e.g. a failure), indications on true root causes, adaptation of any probability value and so on. Computed symptoms e.g. from physical models and performance metrics may be entered automatically as evidences together with symptoms supplied by the operator in the inference engine 21.

The inference engine 21 is arranged to perform a simultaneous verification of a number of root cause hypotheses. The simultaneous processing of the hypotheses can be facilitated by use of causally oriented graphical models. A causally oriented graphical model can be described as being a combination of probability theory and graph theory. The causally oriented models can be seen as models that are oriented based on causal associations the various nodes of the model may have with each other. After the analysis the inference engine 21 may produce a list of the most probable root causes for the event.

The evidences may be propagated through a BN model to produce a list ranking the most probable root causes. Other information such as a list providing an optimal sequence of control, operation and/or maintenance actions may also or alternatively be provided.

The RCA model manager 23 facilitates browsing, searching and filtering of root cause analysis (RCA) models stored in a library of RCA models 33. The RCA model manager 23 may also be used by the operator or another failure analyst to enter observed and/or measured symptoms of the problem domain into the analyser system. The operator may also use the model manager 23 for entering feedback into the analysis system thereby improving the adaptivity of the system.

The data layer 30 is shown to contain entities for storing structured data models in the library 33 of root cause analysis models. These models are stored in a selected format wherein the data is arranged in a logical or structured order (e.g. as an hierarchically structured XML file). The model manager 23 is arranged to input information to and/or retrieve information from the structured data models stored in the RCA model library 33.

The Inventors have found that the structured data format may not always be the best suitable data model for the root cause analysis. A storage entity 32 for storing causally oriented data models generated based on the structured models is thus also provided. The inference engine 21 may access the causally oriented models for purposes of probabilistic reasoning. The causally oriented models enable simultaneous verification of a plurality of hypotheses by the inference engine 21. The simultaneous verification of hypotheses may allow higher computational effectiveness. All observed symptoms and computed variables can be entered as one set of evidences in a causally oriented data model, said model including all hypotheses for a certain event. The values of the evidences do not necessarily need to be numeric values. Furthermore, because reasoning under uncertainties is enabled, it is not necessary to gather a complete set of evidences for each symptoms. Simultaneous propagation of the evidences through a causally oriented model (e.g. the BN model) result in simultaneous verification of a plurality of hypotheses thus speeding up the operation of the root cause analyser.

An example of data structure that can be more readily processed by the Bayesian network (BN) inference engine 21 is a graphical BN model that is referred to as a directed acyclic graph (DAG). The directed acyclic graph (DAG) creator 22 is a translation engine that is arranged to generate a directed acyclic graph (DAG) based on structure data such as a hierarchical RCA model. The DAG creator 22 may be provided with a functionality such as a XML parser for the translation of the XML model structure into a causally arranged data structure such as to a directed acyclic graph (DAG).

Other data may also be provided for the analysis. For example, a storage entity 35 for storing data associated with symptoms that have been calculated for certain events and/or a storage entity 34 for storing models describing the facility may be provided. The symptoms may have been calculated by the calculation engine 24 arranged to execute the performance models and/or physical models stored at the storage entity 34. The inference engine 21 may then provide analysis of possible root causes based on evidences entered by the operator into the model manager 23, evidences from the control system, and evidences from the storage 35 of calculated symptoms. The control system may provide the model manager automatically with the evidences, e.g. in response to a predefined event, periodically and so on.

It shall be appreciated that the FIG. 2 block diagram is only a schematic presentation of a possible arrangement for the analyser arrangement showing possible entities and their relations. It shall also be understood that although the entities for analysis and for generation of the causally oriented data models are shown in a single presentation, these functions may be implemented in remote locations. For example, data generation may be accomplished by the provider of the data models whereas the actual analysis based on the generated data models and some additional information may be accomplished by the operator of the facility. That is, the data models may be generated in a location and by an entity that is not physically in the same location wherein the data models are used for analysis. For example, the data models may be generated by a specific provider of the data models. The provider may also be the holder of the structured RCA models and/or other gathered data about the subject of the analysis.

In accordance with an embodiment, the analyser is provided with a translator function (e.g. the DAG creator 22 of FIG. 2) thereby allowing the analyser to process causally oriented data models which the analyser itself may create based on structured data stored in the storage entity 33.

A feature of a causally oriented data model is that it contains information regarding the so called chain causalities. The chain causalities allow identification of the possible root causes of a failure. The causality also allows simulations of possible consequences of interventions e.g. by an operator to a process.

A causal directed graphical model is typically built of discrete and continuous decision nodes or objects. The graphical structure of the model is based on assembly of root cause and effect nodes “connected” by the causality links. The causality links present probability potentials. That is, an causality link from node or object A to node B can be seen as indicating that node A is likely with some certainty to “cause” node B. The causality links are sometimes referred to as ‘arcs’. The causality links may be based on appropriate probabilistic methods.

The input for the discrete nodes can be classified into different states. In substantially simple applications parameters such as binary states or intervals of typical parameter variations can be used. The input in the continuous decision nodes can be any type of random variable distribution. For example, Gaussian distribution or superposition of several Gaussian distributions may be used to approximate any continuous distribution.

Conditional probability distribution (CPD) may be assigned for each node of the graphical model to complement the structure thereof. If the variables are discrete, the distribution can be represented by means of a conditional probability table (CPT) with respect to the parents of the node. The table lists the probabilities a child node has on each of its different value for each combination of values of the parent node thereof. The inventors have found that the data models to be analysed may be adapted to take e.g. changed conditions into account by modifying the conditional probability tables.

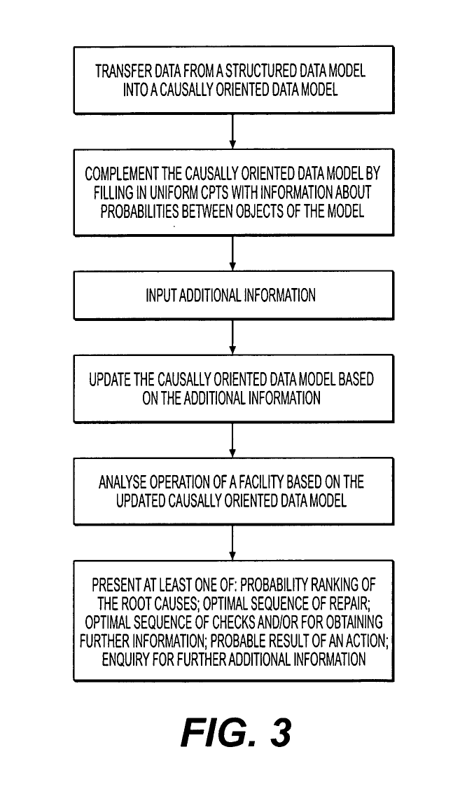

An initial causally oriented data model may thus be complemented and/or updated based on additional information, as shown in FIG. 3. That is, a completed BN model can be generated based on said directed acyclic graph (DAG). The completion may be based on quantitative information from another type of structured data associated with conditional probability distributions between at least two objects. The adaptation may be based on any information that may influence the probabilities between the objects of the model. For example, the tables may be updated by recalculating the probabilities from quantitative data associated with failure frequencies and/or failure weightings of variables in the causally oriented data model. The conditional probability tables may also be generated and updated based on existing expertise and/or data regarding the facility such as statistical and/or physical and/or process models, on experience (e.g. on the operator belief on causality) and so on. The models may provide an appropriate base of structured knowledge for incorporation into the causally oriented model structure.

The completion and/or adaptation of the directed acyclic graph by at least one conditional probability table can be seen as an operation that corresponds to filling the uniform CPTs with typical values of conditional probabilities for a certain state of a child (effect) object under the condition of certain states of the parent (cause) object(s). These typical values of conditional probabilities represent the conditional distributions for the discrete or continuous random variables (=nodes i.e. objects) in the BN. The data model may thus contain the directed acyclic graph that is complemented with at least one conditional probability table.

Alternatively expressions may be defined, said expressions representing the conditional probability distribution of variables i.e. objects in the causally oriented data model.

The conditional probability tables thus provide information regarding the causality relations between the variables thereby allowing probabilistic reasoning under uncertainties. More particularly, a conditional probability table may express causality relations in terms of conditional probabilities between the child node (e.g. observed/measured/calculated symptom or effect) and its parent nodes (e.g. the causes or conditions causing changes in the child node states).

The completion of the acyclic graphs may be accomplished by an expert or automatically by filling in the conditional probability tables with probability values. An expert of the problem domain may provide information such as the failure frequencies (recalculated to prior probability) and ranked weightings of the possible root causes (recalculated to root cause probabilities). The obtained probabilities may be transferred by means of an appropriate program code means (e.g. Visual Basic™) into the Bayesian network (BN) in order to complete and/or update the CPTs and thus provide default probability setting in the library of Bayesian models before evidences are propagated through the BN. The root cause probabilities may also be updated based on the results of the propagation of the BN model through the BN of the inference engine.

The filling may be automatic and be accomplished by statistical processing of database information related to failure frequencies in the problem domain. The probability values may also be based e.g. on statistics of the problem domain such as the frequency of the failure or a database of representative earlier cases for the same failure type. The values may also be based on operator expertise on the problem domain, on operator's beliefs and/or experience on the probabilities and so on. This information may have been gathered from a plurality of sources, such as from testing laboratories and other similar facilities.

Creation of the initial BN graphs can be done automatically i.e. without intervention by the user. This saves development time. Use of data that already exist in a hierarchically organised data structure may also reduce significantly the engineering efforts on transferring the collected domain knowledge and operator experience that is obtained e.g. through interviews on the plant into BN compatible graphs.

The skilled person is familiar with the principles of a Bayesian Network (BN) and the elements of a Bayesian system, and these are therefore not explained in more detail herein. Those interested can find a more detailed description of the directed graphical models and conditional probability distribution e.g. from an article ‘An introduction to graphical models’ by Kevin P. Murphy, 10 May 2001 or from a book “Bayesian networks and Decision Graphs” by Finn Jensen, Aalborg University, Denmark, January 2001.

The BN models may be stored in the data storage means for later use by the inference engine 21 of the analyser. The BN inference engine 21 may fetch an appropriate BN model from the library of models 32. The selection of the required model can be done automatically from the Bayesian Model library based on observed failure and problem domain.

In accordance with a further embodiment the inference engine 21 may also access evidences automatically from a control system such as a distributed control system (DCS). The operator may also input evidences. The evidences may be propagated through the BN model 32 to produce a guidance list with ranking of most probable root causes and a list providing an optimal sequence of control, operation and/or maintenance actions.

The various entities of the processing layer may access additional information via an interface entity 10 of a control module 40. The control module 40 may comprise an automated functionality for controlling a facility. It may be integrated with an operate module 10 to provide a user interface for operators. The control and operate modules may be provided on a common control platform.

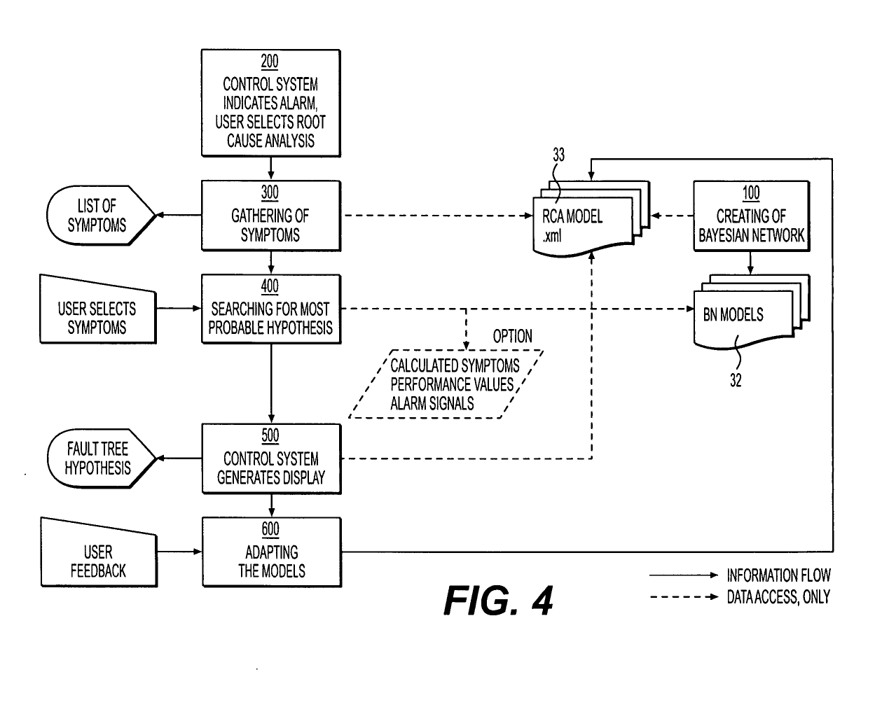

FIG. 4 shows an adaptive scheme for automated simultaneous verification of several root cause hypotheses based on Bayesian technology. The first step of the scheme comprises translation of a hierarchical XML data structure through XML parsers into a directed acyclic graph (DAG). This step may be performed by the provider of data models for analysis. The DAG contains for each causality link of the graph a uniform conditional probability table which will then be filled in i.e. completed (if necessary) with probability values. The probability values are representative of the particular problem domain thereby enabling generation of a BN model for root cause analysis representative of the facility to be analysed.

The normal operational behaviour of a facility may change with time, for example because of ageing and replacement components and so on. The adaptive causally oriented data models enable flexible root cause analysis arrangement such that, for example, changes in the problem domain of the facility to be analysed can be taken into account.

The adaptation of the parameters of the causally oriented data model may be accomplished by adapting the quantitative information such as the probability values on the conditional probability tables to correspond the real conditions of the facility. The adaptation of a data model can be done in real-time manner and case to case basis. Thus the data model reflects real-time changes in the facility.

Instead or in addition to adaptation of the parameters of the data model, it is also possible to modify the structure of a data model in accordance with the changed or newly recognised conditions. The structure adaptation can be based e.g. on operator experience, process engineer expertise and so on. The qualitative cause-effect relations of a causally oriented data model such as a BN structure may be subjected to the modification.

To facilitate a BN structure update, all new acquired cases of the facility problem domain may be stored in a database. A periodic BN structure off-line learning procedure may then be performed based on the stored data. According to an alternative, new symptoms and root causes for a certain abnormality may be entered by the operator into the model manager. The model manager may then modify the structured data file (e.g. XML file) and map the new data into a modified BN model structure by the translation function 22.

Before explaining the analysis process of FIG. 4 in more detail, a reference is made to FIGS. 5 to 7 showing in more detail hierarchically and causally oriented data structures while explaining a more detailed example of the generation of the causally oriented graph and completion thereof by the conditional probability tables.

As mentioned above, data about the subject of an analysis may be organised in a structured manner such as in a hierarchical data file structure or model. In a hierarchically arranged data structure a failure object forms the parent object of a hierarchically structured data model generated for a failure. Since there are typically a plurality of possible causes for a failure, the parent object has a plurality of child objects presenting the possibilities. The possibilities are referred to in the following as hypotheses. Each of the hypotheses in turn may parent a plurality of child objects. These are referred to herein as symptoms. The symptoms represent abnormal changes in the process operation conditions, which lead to a failure in the problem domain (e.g. process and/or its operation and/or equipment and/or component) and/or other deviations from optimal conditions.

FIG. 5 illustrates an hierarchical data structure such as an extended mark-up language i.e. XML data structure or any other file that is created based on the Standard Generalised Mark-up Language (SGML) format. The hierarchical structure may be parented by a failure node or object F. The hypotheses form child nodes H1 to H4 of the failure object F. Each of he hypothesis objects H1 to H4 in turn has child nodes S referred to as symptom objects. It shall be appreciated that two or several of the hypothesis nodes HI to H4 may parent similar symptom objects.

If hierarchically structured data is used, the analysis is made so that the operator examines a hierarchically organised data structure displayed to him/her by a display device. The data examination of the possible root cause is then made in the direction:
failure→hypothesis-→symptoms

As mentioned above, use of the structured data may not always be the most desirable. For example, if hierarchically organised data models are used the operator has to select a hypothesis before being able to get a display of the symptoms of that hypothesis, the displayed symptoms forming a checklist for the operator. The operator may need to check each of the symptoms to find the actual root cause for the failure or other deviation from normal operating conditions.

The operator also needs to make intelligent guesses to be able to select a likely (preferably the most likely) hypothesis. The operator may also need to go through a number of hypotheses and the associated symptoms or even all of the hypotheses and the symptoms thereof before being able to determine the actual root cause for the fault. This may take a substantial amount of time.

The user may need to, for example, click several times by a mouse starting from an observed failure he has chosen from a number of options in the failure tree. The user needs to manually select by clicking the hypothesis he believes is the cause of the event, and thereafter check all symptoms for the selected hypothesis. If it turns out that the selected hypothesis is not the correct one, i.e. not the root cause of the problem, the user has to start the procedure again with and select the another hypothesis.

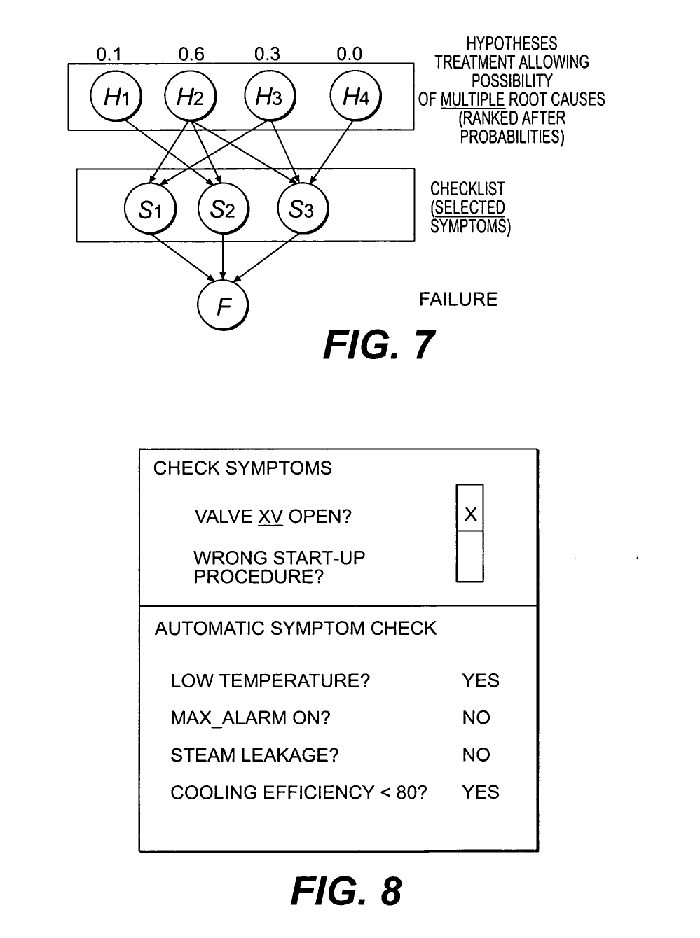

The causality links of a causally oriented graphical data model are, in turn, oriented from cause to effect. FIGS. 6 and 7 show two different types of causally oriented graphical data models into which the hierarchical structure of XML-data of FIG. 5 can be translated.

More particularly, FIG. 6 shows a BN structure wherein a single fault is assumed to have occurred in facility that was working normally until the detection of a failure or abnormality. The single fault assumption is thus represented by a single root cause node with mutually exclusive states. In FIG. 6 each of the mutually exclusive hypothesis of the one hypothesis node H has been assigned with a weight according to the probability of each of the hypothesis H1 to Hn. FIG. 7 shows a BN structure for multiple causes of an observed failure. The mutually non-exclusive multiple root causes are ranked after probabilities as shown on top of each hypothesis node H1 to H4. Each of the hypothesis nodes H1 to H4 is given a weight in accordance with the probability thereof. The causality chain in both of these the causally oriented data structures is:
root cause→symptoms→failure

The probability of the hypotheses i.e. possible root causes may be updated each time the inference engine receives new evidences on the set of symptoms.

As shown by FIG. 5, the hierarchically organised data is stored in the form of a fault tree. The tree may include hypotheses on possible root causes and corresponding checklists (lists of symptoms). For the purpose of a predictive root cause analysis, the symptoms have preferably predictive character to enable analysis based on which it is possible to take necessary corrective actions before any actual failure or other deviation from optimal operation conditions occurs.

As discussed above, the hierarchical failure tree can be mapped into a BN model. An example of the translation is described below assuming that the XML hierarchical data of FIG. 5 has the following structure:
Failure
   Hypothesis 1
      Check point 1.1
      . . .
      Check point 1.n
   Hypothesis k
      Check point k.1
      . . .
      Check point k.m

This structure may be transferred to a DAG such that a failure from the XML model is mapped into an observed effect failure node in the BN model. The check points of the XML model (i.e. the symptoms) are mapped into symptom nodes of the BN model. However, the XML structure does not contain explicitly any causal links. Instead, the XML data is organised in hierarchical levels, where each failure level contains a number of hypothesis sub-levels and each hypothesis sub-level contains as sub-sub-levels a number of checkpoints. These XML hierarchical level-sublevel-sublevel structure, however, can be mapped into causality links (root cause→symptom; symptom→failure) in the BN graph. This can be seen as corresponding to assignment of default CPTs with uniform probability on the corresponding states of all observed symptoms and effects.

The symptom nodes of the BN graph can be of different character. For example, discrete nodes with mutually exclusive states may be provided. The exclusive states may be binary (=Boolean) states such as “yes” (=“true”) when a symptom is observed and “no” (=“false”) when a symptom is not observed. The states may also indicate other features such as the intervals of the symptoms, relative symptoms levels (e.g. the ratio between measured value at an observation time point and value of the last set point) and so on. The symptoms nodes in a BN model may represent parameters that associate with the problem domain such as the performance measurement results, physical variables and so on.

If a single fault is assumed to have occurred (FIG. 6), the states may also represent mutually exclusive types of failures for the same object. For example, a node “plate cut quality” may be provided with states: “OK”, “OVAL”, “CUT NOT STRAIGHT”, “CUT NOT THROUGH”. Continuous nodes may represent continuous random variables with defined statistical distributions, like Gaussian (normal) conditional distribution or superposition of Gaussian distributions.

Several nodes for the states at consequent time points may be used to incorporate symptom trends into the analysis. For example, a trend can be determined based on changes in the symptoms at different time points.

Hypotheses of the XML tree are then mapped into root cause nodes of the BN graph. The mapping of the XML hypotheses into the root cause nodes can be accomplished in different manners depending on the type of the failure (single or multiple causes). The creation of a BN model from a hierarchical failure tree may include different subsequent mapping stages.

A single cause of a failure can be represented by one root cause node, see FIG. 6. The one BN node may have states that are mutually exclusive hypotheses. The main assumption for applying the single fault modelling approach is that everything was properly functioning before the failure was observed. The list of mutually exclusive hypothesis may include a hypothesis ‘normal’ (i.e. no fault).

Multiple root causes of a failure can also be represented by binary nodes with states “yes” and “no” for each hypothesis, see FIG. 7. More than two states may also be used. For example, intervals or trends of the possible cause development can be used as classification criteria.

The next possible mapping stage comprises mapping of the relations of the hierarchically organised XML data structure between the checkpoints and the hypothesis into causality links of the BN graph. The mapping of the causality directions from cause to effect is important for the correct translation of the causality links (expressing dependency relations), which is crucial for the reasoning, i.e. propagation of evidences by the inference engine.

If several hypothesis share the same symptoms, several causality links may then lead from those hypothesis to the same shared symptoms. The mapping will allow creation of causality links within the same parent/child XML structure. The orientation of the links will be defined by the mapping from hypothesis (root cause)→to check points (symptoms)→failure.

An XML model does not contain quantitative data on failure frequencies or statistics, and therefore the XML data does not allow filling of the CPTs with the proper probability values for the corresponding problem domain. The quantitative information on failure frequencies and/or weighing of root causes can be filled in another type of file (e.g. into a spreadsheet such as an EXEL-arc). The other type of file may also contain information regarding the probabilities of the problem domain. The obtained probabilities may be transferred into the CPTs (replacing/updating the uniform/initial default values) in order to complete/update the DAG and to obtain the completed BN model. The transfer may be accomplished by means of another program code.

Under the assumption of a single fault (FIG. 6), the number of the hypothesis is mapped into one root cause node of the BN model with the same number of mutually exclusive states representing the number of hypothesis. An extra state may be used for allowing the possibility of no fault or another fault hypothesis than those already listed.

To incorporate the possibility of multiple faults (FIG. 7), the number of hypothesis from the XML model may be mapped into the same number of root cause nodes in the BN model with Boolean states. Again, an extra root cause node may be employed for the possibility of another fault hypothesis than those already listed.

It shall be appreciated that FIGS. 6 and 7 present only simple BN models and do not show presence of possible causality relations between the different symptoms and/or presence of intermediate causes as effects of the root cause. If causality relations exist between the symptoms the models may be modified to take this into account by adding appropriate causality arrows and the associated conditional probability tables (CPTs). The causality arrows shall be understood as being graphical object that present the conditional probability tables.

Returning now to FIG. 4, BN models are first created based on the RCA models stored at the data storage 33, step 100. More particularly, a Bayesian Network (BN) model comprising a directed acyclic graph (DAG) is created from XML data models. An initial BN graph i.e. a directed acyclic graph (DAG) may be created off-line from a RCA model by the DAG generator 22 of FIG. 2. The directed acyclic graph structure is then completed with at least one conditional probability table (CPT) to build a completed BN model for the diagnostics.

A complete BN model can be created for each fault or other event. A BN model preferably includes the known hypotheses of possible root causes of a failure and/or abnormality. A simultaneous evaluation of all hypothesis can be done by supplying to the inference engine 21 only once all evidences on acquired symptoms from the problem domain. If new evidences are required and supplied later on (e.g. before or during next analysis), all hypothesis are again evaluated simultaneously to provide quick update of the list with root cause ranking. Thus, an on-line adaptive learning functionality of the system can be provided.

In the conventional arrangements such simultaneous processing is not possible. Instead, evidences relevant to a single hypothesis need to be supplied and evaluated separately from similar processing of other hypothesis.

According to a possibility, if several faults share a big number of similar symptoms, one BN model can be generated for simultaneous hypothesis verification on the root causes of several failures and/or abnormalities.

A complete BN data model reflects the hierarchical structure of a hierarchically arranged data structure of the corresponding RCA model 33. If the hierarchical data structure does not exactly include the right order of causality directions (as is the case in FIG. 5), proper causalities can be incorporated into the causal BN model during the translation procedure.

The BN models are preferably generated and stored in the BN model library when the analysis system is developed. That is, step 100 of FIG. 4 may be performed off-line and the BN models for the root cause analysis (RCA) are stored in a database such that the created BN data models can be accessed later on by the analyser entity. The off-line generation of the BN models may save time later on if BN models for a corresponding problem domain are needed. Another advantage of the beforehand generated BN models is that the search may be executed directly on the most probable root causes without requirement for any translations between the two different data structures before the analysis.

At step 200 the control system gives a fault alarm to the operator. The operator decides to use root cause analysis (RCA) to analyse the fault. To initiate the analysis the operator selects appropriate function by means of the user interface of the analysis system, e.g. by the user terminal 10 or a portable user device 40 of FIG. 1. The root cause analysis can also be triggered automatically e.g. in response to a Distributed Control System (DCS) alarm.

The control system may gather evidences i.e. symptoms of the fault at step 300 by loading a corresponding RCA model 33 through the RCA model manager 23. The gathering of evidences may occur simultaneously with the selection of the root cause analysis (RCA) at step 200. The step of gathering may comprise classification of evidence signals gathered as symptoms and additional information. Discrete evidences may be classified into different states and/or variation intervals. Evidences that are of continuous type may be classified into mean and standard deviation (or variance) classes. The classification is preferably accomplished in real-time. The classification function may be included in the root cause analyser 3 or in the control system 1 of FIG. 1. In the latter case the classified signals may be transferred as real-time evidences to the analyser.

The symptoms i.e. the gathered evidences can be propagated through the Bayesian network that is searching for the most probable root causes of the observed fault to update the results of the root cause analysis. The updating may associate with the probabilities of the root causes, probabilities of the appropriate control and/or maintenance actions, probabilities of simulated effects from intended actions and so on.

The list of symptoms may be completed in substantially real-time by operator inputs and/or symptoms provided e.g. the control system. At least a part of the symptoms may be provided by sources such as monitoring and/or measurement functions of the control system. For example, information about the symptoms may be provided by measuring instrument means such as temperature, pressure or moisture sensors, or information gathering means such as video cameras, microphones, smell sensors (artificial noses, gas sensors), microphones and so on. The list of symptoms may be provided automatically by utilisation of control system functionalities such as measurements, calculations or other monitoring parameters which are entered as evidences of the state of symptom nodes. At least a part of the symptoms may be provided manually by the operator in the beginning of the root cause analysis or later as additional evidences to evidences supplied automatically by the control system.

The list of evidences can be completed by automatic computations by appropriate models describing the system, such as performance models and/or physical and/or statistical models. These models may be stored ion the model library 34 of FIG. 2. Use of computational models may be appropriate, for example, in occasions wherein some typical symptoms or a failure might not be easily observable or measurable. This may also free the operator from manually inspecting the device and inputting the symptoms.

Use of the additional evidences associated with the event may make the reasoning procedure more accurate and/or more useful from the operator' point of view, as the additional information may reflect better the real operating conditions and/or operator's knowledge of the facility. By taking the facility performance metrics into account as evidences in a root cause analysis an indication may be obtained whether the facility is operating as its optimal efficiency, output quality and so on.

A simultaneous verification of a plurality of hypotheses can be performed at step 400 based on the information in the BN model. The analysing step determines a weight for each of the possible hypothesis based on the probability thereof, the simultaneous verification being for determining the most probable root cause of a failure. The BN model may be accessed on-line at step 400, for example via a local data network or an IP based data network 14 of FIG. 1. The simultaneous verification of more than one hypothesis together with analysis of a number of variables provides savings in time as compared to the prior art where all hypotheses had to be checked one after the other. Thus, significantly quicker fault isolation may be obtained.

Instead of giving the same weight to every new case or instance acquired from the facility, the older cases may be given less weight. This may be accomplished, for example, by multiplication of the weight by a value between zero and one. It may be especially important to reduce the influence of old history cases following for example maintenance or alteration work on the facility. The root cause analysis system may also utilise only a limited number of cases representative of the problem domain associated with the facility. The exact number of cases to be used for adaptive operation may be dependent on how dynamic the change in the behaviour of the facility is and the amount of flexibility which is allowed for the analysis system to accommodate these changes. The greater the requirement of flexibility of the root cause analysis system, the smaller should the number of history cases be. According to a possibility, in order to take into account ageing of the facility the number of cases to be used for the analysis is kept in a fixed number by always replacing the oldest history cases by newly acquired cases.

Searching for the possible root causes of a failure can be seen as a diagnostic application of the BN model. The probabilistic reasoning in diagnostic applications is performed in direction opposite to the causality links. That is, the inference engine 21 may calculate the probable root causes (hypotheses) starting from the observed failure and then from symptoms without being forced to select the hypotheses first. The evidences (symptoms) are propagated through the BN model in order to search for the probable root cases of the observed fault.

In addition, the causality structure of the network allows examination of the impact of intended interventions, which can be very useful for control of complex processes in order to predict what will happen if an action is taken. This may be especially advantageous in association with actions that may have serious unwanted or dangerous consequences.

At step 500, a ranking of possible root causes is displayed for operator. The obtained root causes may be ranked based on their probabilities before being presented to the operators and/or maintenance personnel. This may be used to provide improved operator guidance and decision support on control and/or maintenance activities.

It shall be appreciated that the analysis may also comprise other stages in addition or as an alternative to the above described automated creation of causally oriented acyclic BN graphs from the existing hierarchical data structures. The analysis does not necessarily need to be based on a causally oriented data model.

The data models can be adapted at step 600 to more accurately correspond the real life and real-time conditions. The BN models may be updated during the use of the analysis system based on user feedback thereby providing an analysis which takes the user feedback into account. The adaptive analysis based on the Bayesian Scheme may be provided by means of combined evidences. Completion of the conditional probability distributions can be provided by means of manual or automatic update of the information base. The automated update can be utilised in provision of a learning system that is adaptive to e.g. changes in the process, equipment and/or operation conditions. The changes may be caused by various factors, such as ageing, new components, new operation modes, maintenance actions, and so on.

Adaptive analysis may be provided by updating the BN model with new symptoms, new root causes and the CPTs. The update may be accomplished e.g. based on operator feedback at the end of an analysis and/or by tuning the BN with failure cases representing the problem domain. The feedback may be input via any appropriate user interface.

If adaptive BN analysis scheme is used the operator may be provided with explanation through highlighting the chain of causality in the fault trees. This may be accomplished in a plurality of ways. For example, different colours, blinking elements or animated elements and so on may be displayed on a display screen. This may make it easier for the operator to understand the system and make him/her more confident with the system.

The original BN model may incorporate only default probabilities between causes (hypotheses on possible root causes) and effects (observed or measured symptoms). Addition of new symptoms to existing BN models may require additions and changes in the CPTs. Adaptive operation based on operator feedback and changes in causality relations may be realised through an update of the CPTs of the model, e.g. by adding experience counts and fading factors.

The update may also be done periodically, e.g. based on feedback by the operators or information from a monitoring system within a certain period of time. The update may be triggered manually or automatically. The automatic triggering may occur in response to an event or based on a timer function.

An editor interface display may be presented for the operator. The operator may then specify the weights of any new symptom relative to the existing symptoms based e.g. on experience. An automated analysis of the relations between the added symptoms and the existing symptoms may also be provided in more advanced solutions. The automated weighting may be based e.g. on statistical and/or physical models about the facility of part thereof.

FIG. 8 shows a Graphical User Interface (GUI) that may be presented to the operator for selecting the observed symptoms after the operator has selected root cause analysis. The user interface may present a list of representative symptoms for a fault domain. The operator may then choose from the presented list the observed/measured symptoms of the fault.

In the FIG. 8 example the displayed list contains two options. In addition, the display also gives information regarding those symptoms that are entered automatically into the analyser. The computed, measured or otherwise automatically supplied symptoms may be provided in the checklist e.g. if the value of a specific symptom parameter is greater or lower than a threshold for said parameter.

The operator may select all symptoms from the symptom list of a failure indicated to him/her as an alarm. The combination of the selected symptoms may then be entered as evidence to the Bayesian inference engine 21 for the hypothesis verification to produce a list of possible root causes. The mapping may be accomplished by the DAG creator 22. This is done by mapping the object of FIG. 5 into the data model of FIG. 6 (single fault assumption) or FIG. 7 (multiple faults possibility).

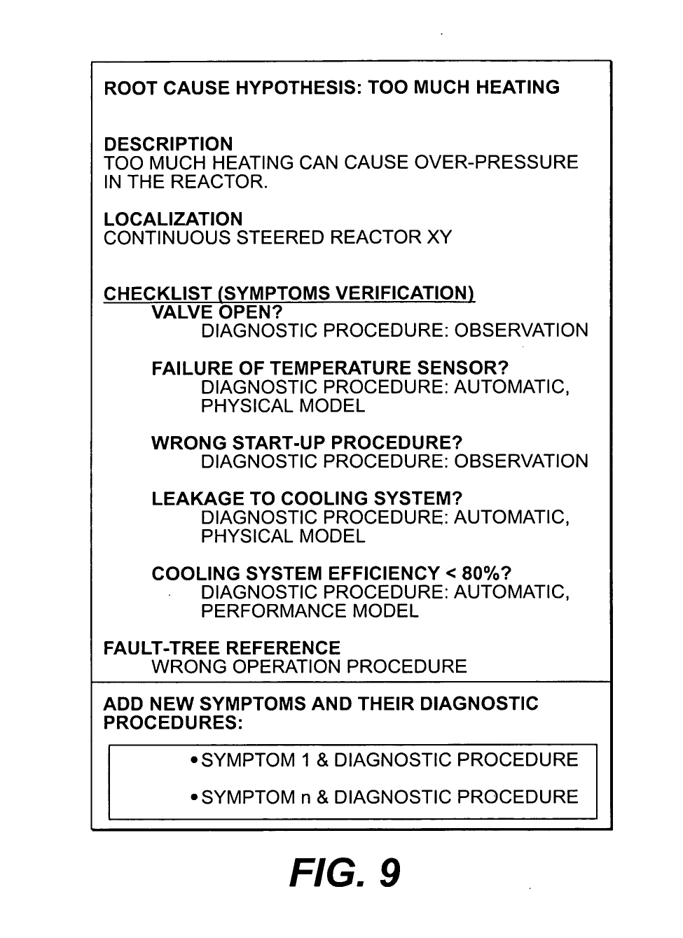

The operator may have been given an alarm such as “Too high pressure in a continuously steered reactor”. After selection of the root cause analysis, the list of FIG. 8 is presented. FIG. 9 shows a further GUI display that may then be presented as a result of the analysis. The display may also give necessary explanations and conclusions on the most probable root causes. The may also be presented with a Bayesian graph showing the chain causality of events leading to the indicated alarm.

The user may also be presented with a graphical user interface that enables input of user feedback, if this is deemed necessary for adaptation of the BN models. Thus the FIG. 9 display also includes a frame wherein the user is enabled to input new symptoms and/or their diagnostic procedures. The structured data files (e.g. an XML document) may then be edited based on the user input.

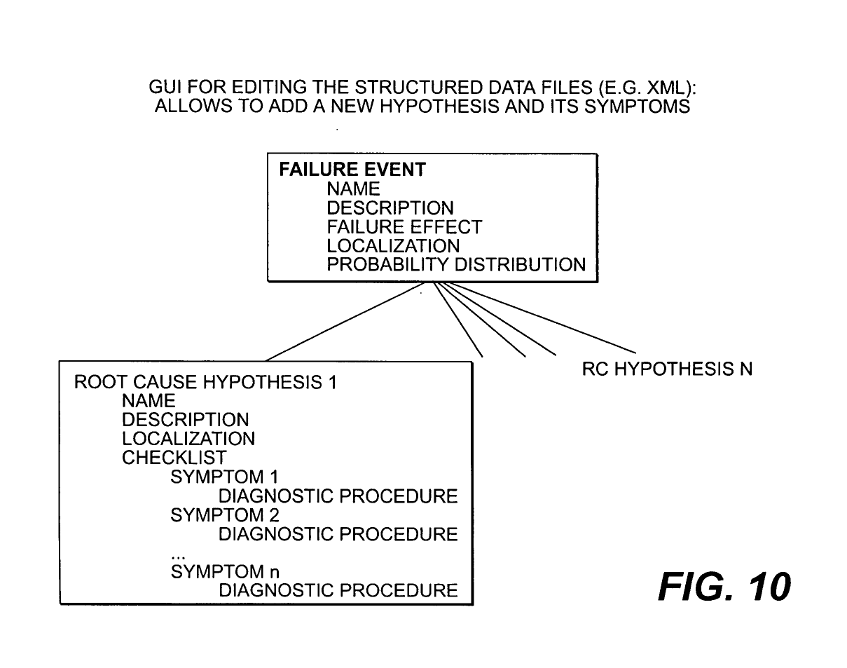

FIG. 10 shows a hierarchical arrangement of graphical user interfaces that may be displayed for a user to enable him/her to edit the data models.

The gathered symptoms about the problem domain may be of predictive character. The symptoms may be predicted e.g. based on time series information from sensors or other monitoring means.

Any time series data for analysis may be processed by other techniques as well. For example, hidden Markov models, Bayesian confidence propagation neural network, recurrent neural network, neuro-fuzzy network and so on could be used for this. The data series analysis may be employed for analysing changes of symptoms relative to the time e.g. based on signals from the distributed control system.

The proposed diagnostic system may be implemented by means of object oriented programming techniques wherein at least some features are provided as an aspect of an object. The aspect and objects can be employed in a platform of a control system that is adapted for object oriented data processing. Object oriented programming techniques or languages were developed to ease incorporation or integration of new applications in a computerised system. A data object may represent any real life object or equipment such as, without being limited to these, a device or a component of a device, a cell, a line, a meter, a sensor, a sub-system, a controller, a user and so on. An aim of the object oriented techniques is to break a task down to smaller autonomous entities that are enabled to work together to provide the needed functionality. These entities are called objects.

During development of a set of control instructions or control software based on the object oriented techniques the designer may determine what objects are needed for the instructions and the interrelations each of the chosen objects has with other objects. When the control program is run a functionality of the program may call an object that is stored e.g. in a database of the control system. A feature of the object oriented methods is that an object can be called and located by the name of the object.

An object may have different aspects, each aspect defining more precisely features such as a characteristic and/or function and/or other information associated with the object. That is, an object may associate with one or more different aspects that represent different facets of the entity that the object represents. An aspect may provide a piece of the functionality of the object. An aspect may be either exclusive or shared by several objects. An object may also inherit an aspect from another object. The different facets of a real world object may comprise features such as its physical location, the current stage in a process, a control function, an operator interaction, a simulation model, some documentation about the object, and so on. The facets may be each described as different aspects of a composite object. A composite object is a container for one or more such aspects. Thus, a composite object is not an object in the traditional meaning of object-oriented systems, but rather a container of references to such traditional objects, which implement the different aspects. Typically the composite object would be a software object representing a real world entity.

International publication No. WO 01/02953 entitled “Method of integrating an application in a computerised system” is a more detailed description of a method to represent real world entities in a computerised system. In such a method and system, different types of information about the real world entity may be obtained, linked to the real world entity, processed, displayed, acted on, and so on. An application that may be used to provide some function of real world entity defines interfaces that are independent of the implementation of the application itself. These interfaces may be used by other applications, implementing other aspects or groups of aspects of a composite object. The WO publication No. 01/02953 describes also a method in which a software application can query a meta object such as an object representing a real world entity (entity object) for a function associated with one of its aspects. A reference to the interface that implements the requested function can then be obtained through the entity object. In the present invention at least some features of the diagnostic system may be integrated as an aspect of an object in the control system platform and/or accessible to the control system.

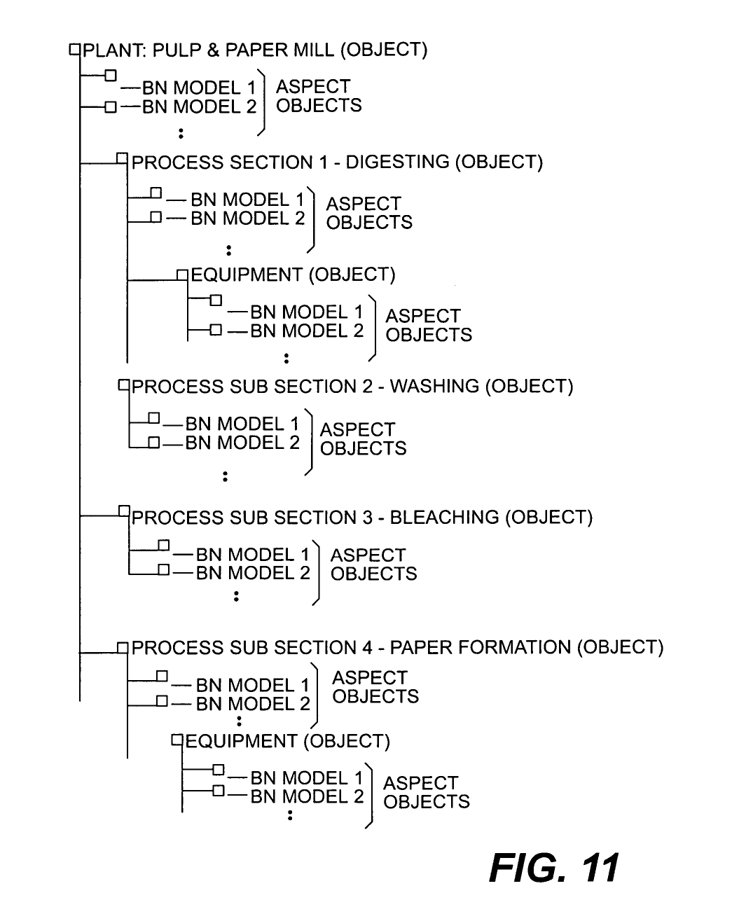

FIG. 11 shows possible real world objects and the associated BN models for a continuous process such as for the pulp and paper mill of FIG. 1. The BN models are integrated as aspect objects in a model describing the entire process of the pulp and paper mill. Each process stage can be modelled separately and included as an object aspect in the pulp and paper mill model.

If an update of the BN model is required, e.g. if new symptoms, new root causes and/or changes in the CPTs are introduced by the operator, the update may be accomplished by updating the aspects in the model and/or by replacing the affected aspect in the model.

The analysis system and/or data models for an analysis can be accessed through a data network, for example through the Internet or an Intranet or other data network 14 operating in accordance with the internet protocol (IP) as shown in FIG. 1. The process operators of maintenance personnel may be enabled to speed up the analysis of the root causes of problems, or confirm their own diagnosis in critical control actions by accessing a remote database via the data network.

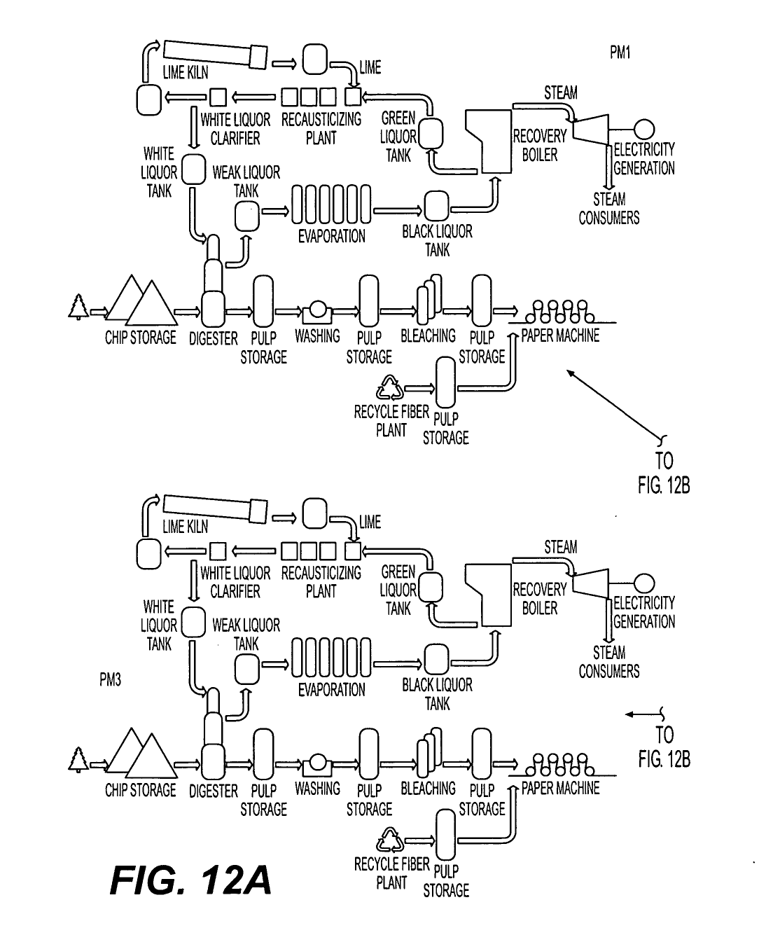

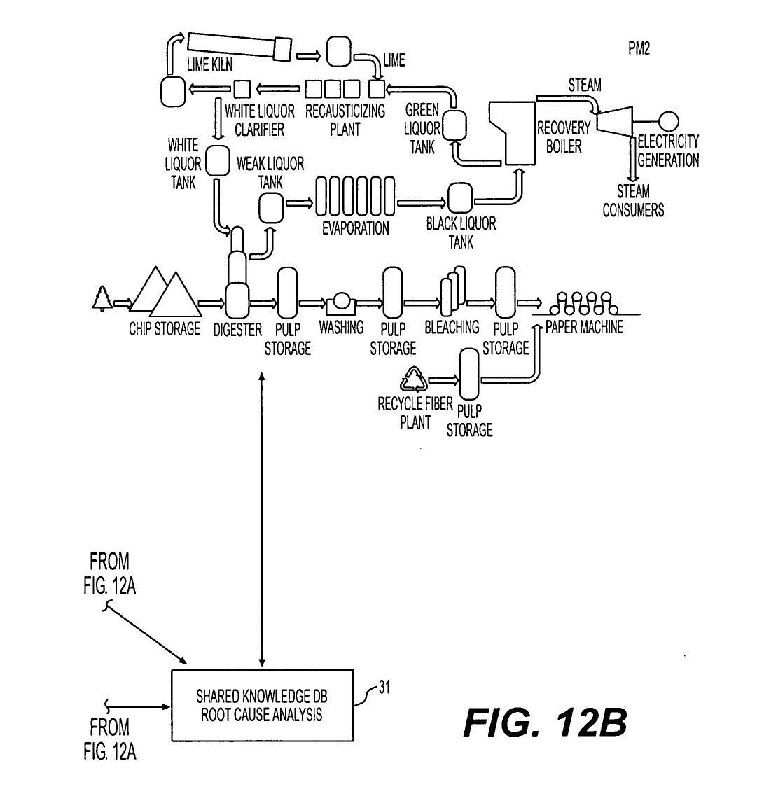

The remote database may include a number of components. Each component may be used for root cause analysis of different, but related failure or other problems. As shown by FIG. 11, a shared database 31 may be provided wherein an individual organisation such as individual factories anonymously store data regarding failures, malfunctions, problems and so on. In the FIG. 12 example the individual factories are shown to comprise pulp and paper mills PM1 to PM3. This enables creation of an extensive statistical database with cases representing domain applications and their typical or chronicle problems.

The shared database 31 provides several advantages. The database is broadened enabling the analysis system to fine tune and complete its structure. All customers may benefit from the improving system since an organisation may apply data learned from other organisations the to their own production. An Internet based system may be accessible for only those customers who have subscribed to it. An intranet system of an organisation may be a global system including tens or hundreds of remote facilities.

The remote database 31 may be provided by an independent service provider. To avoid misuse of the system for example for competitor fraud attempts for example by intentionally manipulated incorrect data or by non-consistent data, the Bayesian technology may be used to provide a data conflict analysis to identify, trace or resolve possible conflicts in the acquired observations. By certain double check procedures for data acquisition, a sensitivity analysis on the parameter observations can be performed.

According to a possible implementation the shared database is accessible over the Internet (See FIG. 1) or over a network such as a LAN or an intranet. A dedicated web site for one or more databases may be established according to the known art of providing web sites. In most cases the web site will include access and log-in processes suited to different types of users and to users carrying out different tasks. Log-in procedures and means to provide them are well known to those skilled in the art of providing web sites. When an information provision and/or data fetching system is established, for example, a first type of log-in is provided so that the operator can select and specify information such as technical requirements, matching schemes, reporting destinations and requirements, reporting format, reporting media, normal and exception reporting measures, contract type and billing details. Subsequent log-ins may then be used by an operator to update or alter configuration aspects such as reporting requirements, dial-up phone number and so on.

A second type of log-in may be provided for access by the analysis system to the database for fetching at least one BN model. There may be more than one type of log-in process for the second type of log-in according to a predetermined access mode and, for example, degree of security and or validation required by the owner or operator of the system.

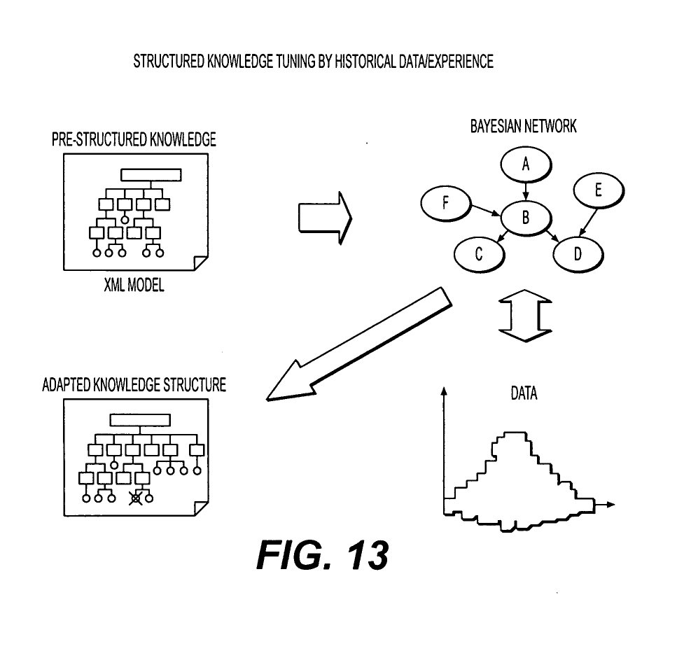

FIG. 13 shows a still further embodiment of the present invention wherein the causal data model is tuned based on historical data and/or experience after creation thereof. This results in an adapted knowledge data structure as shown in the lower left hand corner of FIG. 12. As can be seen some of the root causes are determined as being of minor importance and are shown to be crossed out from the adapted knowledge data structure, and will be ignored in any future analysis.

The tuning may be based on any data. The tuning by data or experience will update the BN model and extract conditional probabilities for decision support. Operator feedback may function as fine tuning in the procedure of automating the creation of the BN model.

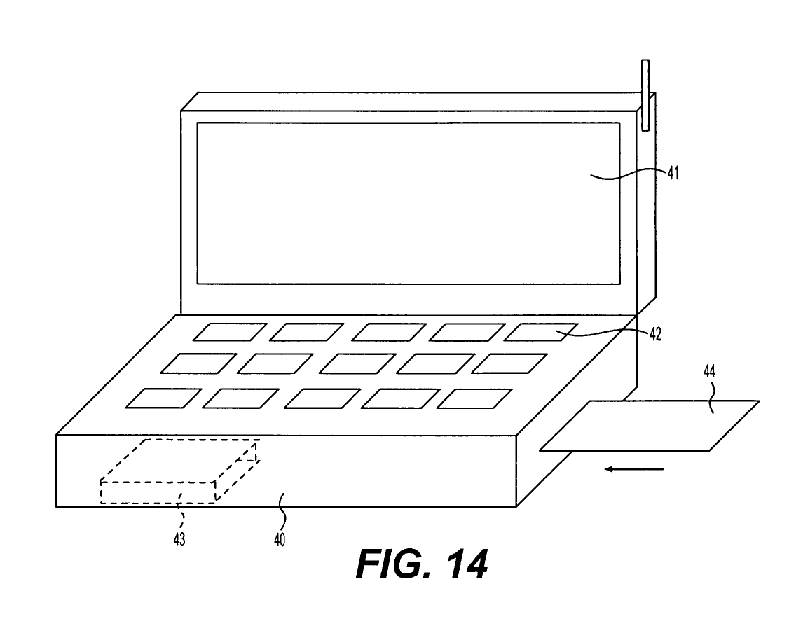

A still further embodiment is described with reference to FIG. 14 showing a portable user interface device 40. An industrial process or other facility may contain a number of manually operated devices 5 (such as valves, switches, gears, process stages and so on). The manually operated devices may be located substantially far away from the operator's workstation 10. Because of this there may from time to time exist a need for a tool for helping the operator e.g. to input the symptoms in the system at the spot, that is whenever he/she feels it necessary to provide such information for the analysis system. The portable device 40 is adapted to allow the operator to input data after manual inspection of symptoms or devices e.g. for collection of data for an update of a data model associated with the facility.

The user interface of the portable device 40 may comprise input means, such as control buttons 42 and/or a touch screen and/or a voice recognition means. The input means allow the operator to enter new evidences after manual inspection of symptoms or devices, remotely execute an update of the root cause analysis resulting in an updated list of root causes.

The portable device 40 may comprise a display 41 or other user interface (e.g. one based on voice messages, indicator lights and so on) for representing a ranked list of possible causes and the optimal sequence of control and/or maintenance actions or any other actions the operator could take. The display 41 may also present guidance such as an optimised path how to walk or otherwise move around in the plant, or an optimised time after which a check needs to be made on those local instruments which are not sending automatic input to the control system 1. An optimal sequence of actions and so on may be presented to the operator until the source of the failure or abnormality is found and removed, the list of actions being updated based on the operator's observations while moving around.

The portable device 40 may be arranged communicate with the control system 1 and/or the analysis system 3 of FIG. 1 via a wireless interface. Thus the device 40 can be used to improve the chances that correct information is input in substantially real-time manner into the control and/or analysis system. The portable device 40 may thus improve the chances that correct and up-to-date information is input in a substantially real-time manner into the analysis system.

Alternatively or in addition, a beforehand prepared data model may be stored in the portable or otherwise mobile device 40. The portable device 40 itself may be provided with an analyser function. All processing associated with the actual analysis may then be performed at the portable device. The data may be stored e.g. in the fixedly mounted storage means 43 of the device (e.g. a memory chip or card), and/or in a replaceable data storage medium such as a data diskette 44. All functions that were described with reference to the analyser 3 associated with the control system 1 may be provided by the analyser 40.

The embodiments of the invention may be employed, for example, in a diagnostic arrangement which exploits a probability based approach for reasoning under uncertainties in an analysis system providing root cause analysis.

The adaptive analysis system may provide a quick and flexible troubleshooting and/or predictive diagnostics tool for operators of complex systems. For example, after maintenance, repair or reconfiguration work the data can be readily adapted to changed conditions. Additional data that has been obtained from a facility may also be used in the analysis of another facility as this additional data can be readily introduced in a system for analyzing said other facility.

Creation of the BN graphs automatically (i.e. without intervention by the user) based on existing structured data provides also several advantages, for example, by saving development time. Use of data that already exist in a hierarchically organised data structure may also reduce significantly the engineering efforts on transferring the collected domain knowledge and operator experience that is obtained e.g. through interviews on the plant into BN compatible graphs.

A further advantage is provided by the possibility to easily add new failure symptoms into the existing hierarchically organised data. This can be realised through a user interface to the data structure that allows user feedback for automated update of the existing data models after the step 500 of FIG. 4. This approach allows flexibility for adaptive learning on-line of the updated cause-effect relations resulting in updated BN graphs.

Simultaneous verification of a plurality of hypothesis is a feasible solution since all observed symptoms can be entered as one set of evidences in a single BN model. For example, a evidence vector containing numeric values of evinces could be propagated through a BN model. All hypotheses for a certain failure may have been built into said BN model (see the BN models of FIGS. 6 and 7). This may allow higher computational effectiveness. The simultaneous hypothesis verification may speed up considerably the troubleshooting e.g. in a complex industrial facility.

A further advantage provided by the use of causal networks lies in the causality itself which allows, in addition to monitoring, diagnostic, and troubleshooting, simulation of the impact of an operator intervention before any real action is performed. This may be crucial e.g. when the consequences of certain operator actions may be undesired e.g. for safety or economic reasons.

The root cause analysis may be used especially advantageously in systems wherein substantially complex causality processes of failure and/or abnormality may build up. The root cause analysis tool may also be advantageously employed in analysing components, devices, equipment and/or systems comprising both hardware and software components. The above proposed solutions shorten the time required for searching a fault substantially relative to the time wherein a search is done without an automated system for creation of the data for the analysis. This may lead to reduction in the costs related to failures and/or abnormalities and other events in a process, equipment, devices, components and so on. Time consumed by unplanned process stops, production losses, losses due to wrong production parameters and poor quality, unnecessary consumption of materials and energy may provide significant advantages. The system also may be used for reducing operation and maintenance costs, manpower costs for failure searching and so on. Therefore the overall productivity and efficiency of a facility may be increased by means of the above proposed embodiment.

The solution may be applied to any industrial facility or other complex facility. For example, but without being limited to these, the solution can be used by industrial facilities of metal, foundry, pulp, paper, cement, minerals, chemical, oil, gas and other petrochemicals, refining, pharmaceuticals, food and beverage, automotive industries, automatic storage and/or handling systems (e.g. freight handling systems) and so on. The solution may be used in association with new equipment/systems or existing systems.

It is noted herein that while the above describes exemplifying embodiments of the invention, there are several variations and modifications which may be made to the disclosed solution without departing from the scope of the present invention as defined in the appended claims.

1. An analyzer arrangement for provision of information about a facility by means of root cause analysis, comprising:
storage means for storing a data model that associates with the facility, said data model containing information about possible events, hypotheses for the root causes of the possible events and symptoms for the hypotheses;
processor means for root cause analysis based on the data model;
input means for input of additional information for use in root cause analysis; and
adaptation means for modifying the data model based on the additional information.

2. The analyzer arrangement according to claim 1, wherein the processor means is arranged to process a causally oriented data model.

3. The analyzer arrangement according to claim 2, the causally oriented data model comprising a plurality of objects and information associated with conditional probabilities between the objects, the adaptation means being arranged to modify said conditional probabilities.

4. The analyzer arrangement according to claim 3, wherein the conditional probabilities are modified by modifying at least one conditional probability table of the causally oriented data model.

5. The analyzer arrangement according to claim 1, the adaptation means being arranged to modify the structure of the data model.

6. The analyzer arrangement according to claim 2, wherein the processor means processes simultaneously at least two root cause hypotheses.

7. The analyzer arrangement according to claim 6, wherein said at least two root cause hypotheses share at least one common symptom.

8. The analyzer arrangement according to claim 2, wherein in the causally oriented data model a hypothesis object refers to at least one symptom object and said at least one symptom object refers to an event object.

9. The analyzer arrangement according to claim 2, wherein the causally oriented data model is generated based on a structured data model by a translator engine.

10. The analyzer arrangement according to claim 9, wherein the adaptation means is for modifying the structured data model.

11. The analyzer arrangement as claimed in claim 2, wherein the causally oriented data model comprises a Bayesian Network.

12. The analyzer arrangement according to claim 1, wherein the additional information is for adapting the data models in accordance with changes in the facility.

13. The analyzer arrangement according to claim 1, wherein the additional information comprises information about events occurred in association with the facility.

14. The analyzer arrangement according to claim 1, wherein the additional information comprises operator feedback.

15. The analyzer arrangement according to claim 1, wherein the additional information comprises information about new symptoms.

16. The analyzer arrangement according to claim 1, wherein the additional information comprises information about new root cause hypotheses.

17. The analyzer arrangement according to claim 1, wherein the additional information comprises information from a system controlling the facility.

18. The analyzer arrangement according to claim 1, wherein the additional information is provided based on quantitative data associated with failure frequencies and/or failure weightings of variables associated with the facility.

19. The analyzer arrangement according to claim 1, wherein the additional information is provided based on expertise and/or experiences and/or historical data.

20. The analyzer arrangement according to claim 1, wherein the additional information is based on statistical and/or physical and/or process and/or performance models of the facility.

21. The analyzer arrangement according to claim 1, wherein at least a part of the structure of the data model is based on causality relations between variables associated with the facility.

22. The analyzer arrangement according to claim 1, further comprising a classifier for substantially real-time classification of the additional information and symptoms before they are input as evidences into the root cause analysis.

23. The analyzer arrangement according to claim 1, further comprising a user interface for selection of at least one symptom.

24. The analyzer arrangement according to claim 1, wherein the data model is stored as an aspect of an object in a model describing a facility.

25. The analyzer arrangement according to claim 24, wherein the data model can be adapted to better correspond the facility by replacing the aspect containing the data model with an aspect containing an adapted data model.

26. The analyzer arrangement according to claim 1, further comprising a storage means for storing the data model, said storage means being accessible via a data network.

27. The analyzer arrangement according to claim 1, wherein the data model is generated and stored in a central storage entity based on information from a plurality of individual sources.

28. The analyzer arrangement according to claim 1, wherein an item of data associated with the analysis is transmitted via a wireless interface.

29. The analyzer arrangement according to claim 1, further comprising a portable user device provided with a user interface for input of symptoms and/or additional information and/or for displaying of the results of the analysis.

30. The analyzer arrangement according to claim 1, wherein the processor means analyses the data model to simulate possible impacts of an intended action before any real action is performed.

31. A method of analyzing a facility by means of root cause analysis, comprising:
preparing and storing a data model that associates with the facility in storage means, said data model containing information about possible events, hypotheses for the root causes of the possible events and symptoms for the hypotheses;
input of additional information associated with the facility; modifying the data model based on the additional information; and
analyzing the facility based on the modified data model.

32. The method according to claim 31, further comprising:
transferring data that associates with the facility from a structured data model into a causally oriented data model and complementing the causally oriented data model with information associated with conditional probabilities between at least two objects of the causally oriented data model; and
simultaneous analysis of at least two root cause hypotheses based on the complemented causally oriented data model.

33. The method according to claim 32, wherein the complementing of the causally oriented data model is accomplished adaptively based on updated information regarding the facility to be analyzed.

34. The method according to claim 31, wherein a structured data model is modified based on the additional information.

35. The method according to claim 31, wherein the additional information is input for adapting the data model in accordance with changes in the facility.

36. The method according to claim 31, wherein the additional information comprises at least one of the following: information about events occurred in association with the facility; operator feedback; information about new symptoms; information about new root cause hypotheses; information from a system controlling the facility; information that is based on quantitative data associated with failure frequencies and/or failure weightings of variables associated with the facility; information that is based on expertise and/or experiences and/or historical data; information that is based on statistical and/or physical and/or process models of the facility; information about the causality relations between variables associated with the facility.

37. The method according to claim 31, wherein the data model is updated in response to a predefined event.

38. The method according to claim 31, wherein the analysis is triggered in response to a signal generated by a control system or an operator.

39. The method according to claim 31, further comprising propagation of a set of evidences gathered for the facility through the data model, making conclusions based on the results of the propagation, and updating the model based on the conclusions.

40. The method according to claim 31, further comprising transportation of data associated with the analysis via a data communication network.

41. A computer program product comprising program code means for performing the steps of claim 31 when the program is run on a computer.

42. A movable user device for use in conjunction with a root cause analyzer for analyzing a facility based on a data model that associates with the facility, said data model containing information about possible events, hypotheses for the root causes of the possible events and symptoms for the hypotheses, the movable user device comprising user interface means for input of additional information for modification of said data model.

43. The movable user device according to claim 42, the user interface being also for presenting results of the analysis.

44. The movable user device according to claim 42, further comprising adaptation means for modifying the data model based on the additional information and analyzer means for producing root cause analyses based on the modified data model.

45. The movable user device according to claim 44 being arranged to process in a substantially real-time manner any new symptoms input into the device.

46. The movable user device according to claim 42, wherein the additional information is of predictive character.

47. The movable user device according to claim 42, arranged to display at least one of the following: an optimal sequence of actions; an appropriate action to be taken by the user of the device; probabilities of simulated effects from an intended action.
